(19) United States
(12) Patent Application Publication
(10) Pub. No.: US 2008/0263509 A1
(43) Pub. Date: Oct. 23, 2008

(54) METHOD AND APPARATUS FOR APPLICATION PATTERNS AND APPLICATIONS GENEARATION

(75) Inventors: David BRUTMAN, Ra'anana (IL); Guy Soffer, Ra'anana (IL); Ouri Levy, Tel-Aviv (IL); Yuval Anafi, Ra'anana (IL); Krithika Manohar, Bangalore (IN); Arno Helmling, Schwetzinger (DE)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: SAP AG, Walldorf (DE)

(21) Appl. No.: 12/103,719

(22) Filed: Apr. 16, 2008

Related U.S. Application Data
(60) Provisional application No. 60/913,279, filed on Apr. 22, 2007.

(51) Int. Cl. G06F 9/44

(52) U.S. Cl. 717/104

(57) ABSTRACT

A method and apparatus for defining and creating generic context-related application patterns, and for defining and creating specific applications based on the application patterns. The method and apparatus include defining generic user interface preferably through interfacing specific environments, and content retrieval preferably through interfacing specific systems, such as enterprise systems. The application development then uses the generated patterns, and the specific user-interface and content retrieval components for developing a specific application.

### RELATED APPLICATIONS

The present application claims priority from U.S. Provisional Patent Application No. 60/913,279 filed on 22 Apr., 2007.

### TECHNICAL FIELD

The present disclosure relates to computer applications design and implementation in general, and to a method and apparatus for constructing application patterns and generating applications based on the application patterns.

### BACKGROUND

When designing and developing computerized applications, multiple applications may share properties, patterns, behaviors and other characteristics. For example, a leave request of an employee optionally shares multiple characteristics with a loan request from a bank, including personal details or the requestor, an approve/reject response which may have to be confirmed by multiple persons, and others. Similarly, request approve/reject applications in different domains may share similar characteristics and patterns. Each such application, however, requires different data depending on its context. Thus, a loan request application may require the balance of the requestor, while a leave request application requires the leave days balance of the employee.

Current application development environments, including application wizards, provide tools for constructing applications. However, these tools are useful in developing specific applications. Application pattern development, and development of specific applications on top of the patterns is not enabled, although this may make application development faster and more efficient. Thus, when designing and developing a new application, a developer can merely copy and paste components of a previously developed application, but the developer then has to enhance, adjust and modify the new application according to the current needs rather than utilize available basic functionality and just add the relevant items. Another problem with existing systems is the lack of context-awareness, e.g., application pattern details, as well as application details, which may have to be modified according to the context in which the application or the application pattern is activated, and may have to be separately designed and implemented for each context, without taking advantage of the known context.

Thus there is a need in the art for systems and methods of developing context-aware application patterns or generic applications, and for developing specific context-aware applications using the generic applications or the application patterns.

### SUMMARY

The present disclosure relates to a method and apparatus for developing context-aware application patterns and applications, so that an application developer can start with an application pattern providing most of the functionality and the user interface, and add the relevant details to the specific application. The application pattern optionally comprises the building blocks of the application, including the user interface components.

One aspect of the disclosure relates to an apparatus for generating an application associated with an application-pattern, the apparatus comprising: an application-pattern generation component, for generating the application-pattern, the application pattern generation component comprising: a generic content-definition component for defining generic context-related content to be consumed by each application associated with the application-pattern; and a generic user-interface-definition component for defining generic context-related user-interface for the application pattern; a specific content-definition component for defining specific context-related content to be consumed by the application; and a specific user-interface definition component for defining specific context-related user-interface characteristics associated with the application. Within the apparatus, the application-pattern is optionally selected from the group consisting of: a workflow pattern; a request approval pattern; a business activity pattern; extending a contact object pattern; an event resolution pattern; a report generation pattern; a document authoring pattern; and a business collaboration pattern. Within the apparatus, the generic context-related content or the specific context-related content optionally relates to one or more items selected from the group consisting of: a user of the application; a role associated with the user of the application; a geographic location associated with the user of the application; computing resources available to the user of the application; and business logic associated with the application. Within the apparatus, the application is optionally a request generation application or a request approval application. Within the apparatus, the generic context-related content or the specific context-related content optionally relates to one or more data items or one or more actions available to a user of the application. The apparatus optionally comprises a contextual data delivery channel. The contextual data delivery channel optionally takes into account settings or preferences by the end-user. Within the apparatus, the generic user-interface-definition component or the specific user-interface-definition component optionally use Microsoft Office as a target user interface.

Another aspect of the disclosure relates to a method for enabling the generation of a specific application, the specific application associated with an application pattern, the method comprising the steps of: defining the application pattern, comprising the steps of: defining generic context-related content for the application pattern; and defining generic context-related user-interface for the application pattern; providing a specific context-related content-definition component for defining specific context-related content associated with the application; and providing a specific context-related user-interface-definition component for defining context-related user-interface for the application. The method optionally comprises the steps of: using the specific context-related content-definition component for defining specific context-related content for an application; and using the specific context-related user-interface-definition component for defining specific context-related user-interface for an application. Within the method, the step of defining the generic context-related content or the step of defining the generic context-related user-interface is optionally performed using one or more methods selected from the group consisting of: using a modeling language; using a visual programming language; using a programming language; using a configuration environment; and using a definition based environment. Within the method, the step of defining the specific context-related content or the step of defining the specific context-related user-interface is optionally performed using one or more methods selected from the group consisting of: using a modeling language; using a visual programming language; using a programming language; using a configuration environment, and using a definition based environment. Within the method, the application pattern is optionally selected from the group consisting of: a workflow pattern; a request approval pattern; a business activity pattern; extending a contact object pattern; an event resolution pattern; a report generation pattern; a document authoring pattern; and business collaboration pattern. Within the method, the application is optionally a request generation application or a request approval application. Within the method, the generic context-related data or the specific context-related data optionally relate to one or more items selected from the group consisting of: a user of the application; a role associated with the user of the application; a geographic location associated with the user of the application; computing resources available to the user of the application; and business logic associated with the application. Within the method, the generic context-related content or the specific context-related content relate to one or more data items or one or more actions available to a user of the application. The method optionally comprises a step of providing a generic context definition component, a step of providing a specific context definition component, a step of defining generic context for an application pattern, or a step of defining specific context for an application.

### BRIEF DESCRIPTION OF THE DRAWINGS

The present disclosure will be understood and appreciated more fully from the following detailed description taken in conjunction with the drawings in which:

FIG. 1A is a schematic illustration of a typical environment in which the method and apparatus of the prior art are used;

FIG. 1B is a schematic illustration of a typical environment in which the disclosed method and apparatus are used;

FIG. 2 is an illustration of user interface of a specific application, developed using the disclosed method and apparatus;

FIG. 3A is a schematic flowchart of the main steps in developing components for generating application patterns and applications, according to a preferred embodiment of the disclosed method;

FIG. 3B is a schematic flowchart of the main steps in generating a generic application and an application according to a preferred embodiment of the disclosed method; and

FIG. 4 is a schematic block diagram of the main components in a preferred embodiment of the apparatus for generating applications.

### DETAILED DESCRIPTION

The present disclosure provides a method and apparatus for constructing application patterns and applications, which are context-aware, i.e. take into account the context of the end-user of the application, including for example his or her location, role, department, supervisor or any other details.

The disclosed method and apparatus enable the characterization and generation of application patterns, by configuring generic context and presentation associated with the application pattern. Based on the patterns, various specific applications are generated by enriching the pattern with custom context-related content and presentation components or actions. The disclosed method and apparatus provide tools for constructing the application patterns and the specific applications.

Multiple applications, although different in context, may be derived from the same or similar pattern or type and require similar types of context-related data from an associated database, and are therefore conceptually similar, from the end-user point of view. For example, vacation request application, loan request application, authorization request applications all share the same pattern of request applications, which may include the requester's details, the approving or rejecting authority, and the request details. The responses corresponding to various requests are also similar and generally comprise approval or reject, and possibly details, reasons, conditions, delegating the response to someone else, barring other approvers from approving, personalizing the response, or free text. Thus, defining a generic pattern of request applications having common properties, such as the requester name, date, or the like will shorten the process of developing one or more specific request applications. Such generic pattern upon which specific applications are developed will also enable uniform look-and-feel and behavior of such applications. The applications are designed and implemented to be used as part of an available productivity suit, such as any standard e-mail system, document control system, or others. Each application comprises content aspects and user-interface, or end-user-experience aspects. The user interface aspects may involve both presentation sides and logic sides. For example, if a certain action is not allowed in a certain situation (business logic side), the relevant button is disabled (presentation side). The content and user interface aspects are generally developed separately to promote the independence of the two aspects. Thus, the enterprise systems which supply the content, or the tools that supply the user experience can be replaced, upgraded or otherwise changed independently.

At least part of the data and options available in each application is context sensitive. For example, an employee requesting an authorization may be presented with fewer options than a manager requesting an authorization, a junior manager approving a vacation will be presented with the requested vacation dates and hours, wherein a senior manager will only be presented with the dates. Another example is hiding from an end-user some predefined field presentation or defining personal alert rules. Thus, some data items or actions may depend on the context, including business logic, for example disabling the option to request vacation on specific dates, the user's identity, role, or geographic location, end user personalization settings, or the like. Other data items or options may be context-insensitive, for example the date on which the request is made.

Additional examples for application patterns include but are not limited to: event resolution pattern, which can relate to rules, possible actions, and tracking options, and can be used for applications such as budget overuse, alert handling or the like; contact creation pattern which can be used for applications such as adding an employee to a company database, adding a supplier, adding a product or the like; report generation and delivery pattern, which can be used for all types of reports; document authoring pattern; business activity pattern; work collaboration pattern or additional patterns.

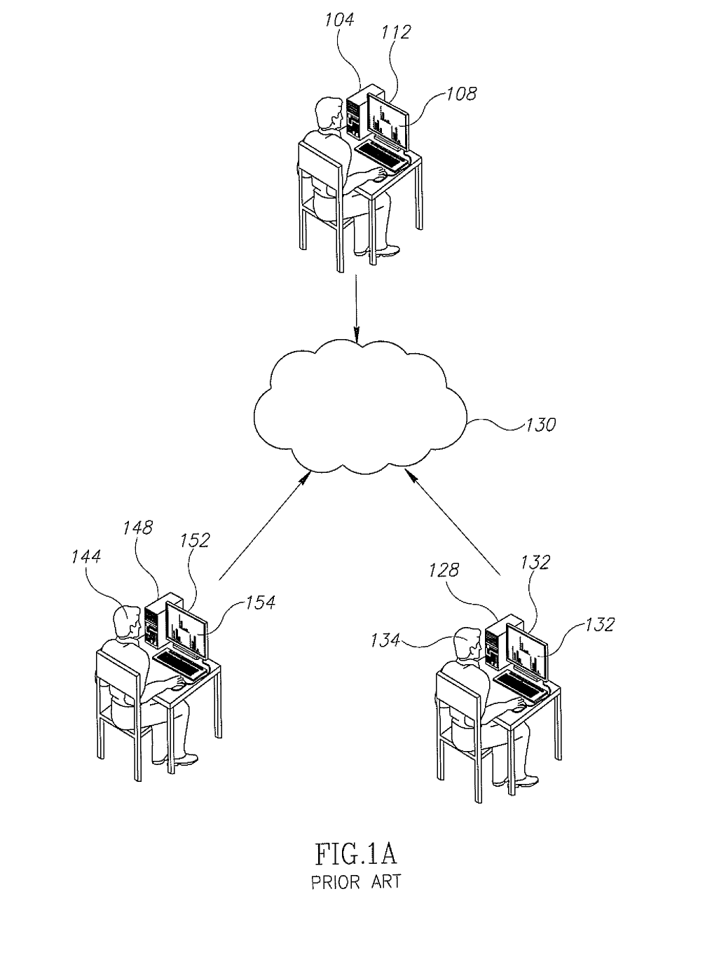

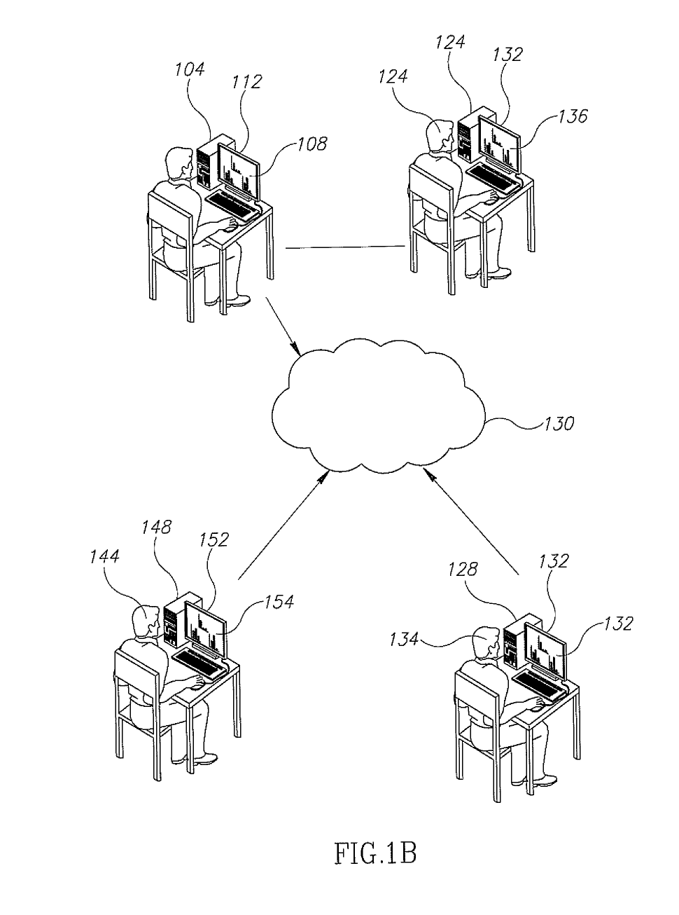

Referring now to FIG. 1A, showing a typical environment in which the prior art is used, and FIG. 1B showing a typical environment in which the disclosed methods and apparatus are used.

In FIG. 1A, an application developer 100 is using a computing platform 104 executing software 112, in order to develop an application. The computing platform can be a desktop computer, a laptop computer, a network computer, or any other platform, including a Personal Digital Assistant (PDA) or others, and uses any development environment or any programming language, including C, C#, C++, VB, VB.Net or others. The application developed by developer 100 is transferred via channel 130 to user 144 using platform 148 executing the application, or to user 164 using platform 188 executing the application. Channel 130 may include the internet, Intranet, Local Area Network (LAN), Wide Area Network (WAN) through which the application may be downloaded, but also any distribution channel, such as a storage medium such as a disk or a DVD, or the like.

In FIG. 1B, developer 124 using platform 128 is developing a generic application, or an application pattern, which is then transferred to developer 100 for development of a specific application using the generic application or the application pattern. It will be appreciated that the generic application or the application pattern are optionally used by multiple developers for development of multiple non-related applications. For example, a workflow application pattern can be developed by a first developer 124 in a first company, upon which a second developer will develop a loan request application, and a third developer will develop a leave request application, the second and third developer using the application pattern as a third party tool. The application pattern is optionally a role-based application pattern, i.e. the application details are derived dynamically according to the context in which the application is executed, such as the role of the user. For example, for a junior manager, any exceeding budget will be reported, while for a senior manager only budget exceeding in a predetermined sum will be reported.

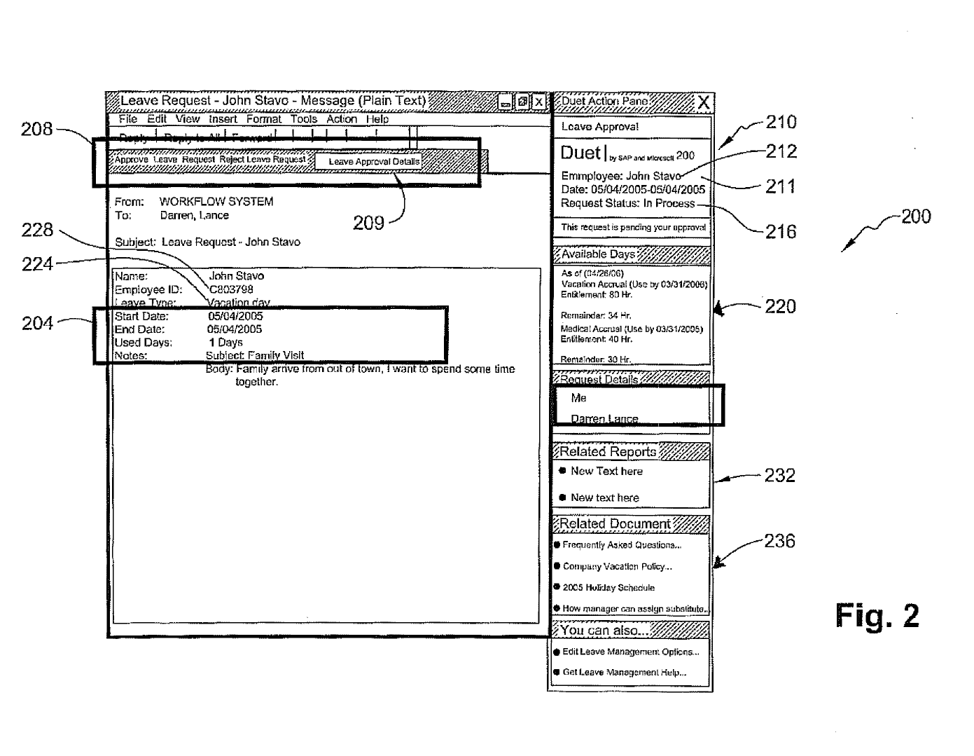

Referring now to FIG. 2, showing an exemplary user interface of a leave or vacation approval application, developed upon a generic approval pattern. The application is generally used in response to a leave request sent by an employee to his or her manager. The application is preferably developed using a “response” application pattern, upon which multiple specific applications can be developed. The application pattern supplies and presents the generic data and actions required in any application of a request-approval type. Then, when developing the specific leave-approval application, only the details and actions specific to a leave request approval are added, thus reducing the development resource requirements.

The user interface, generally referenced 200, is designed to be activated via a standard e-mail mechanism. The user interface comprises data items which are preferably generic and relate to any approval application, as well as data items or actions specific to a leave approval application. One or more shown items, related either to the generic content or to the specific content are role-based and their presence, appearance, or content may change according to the application state, for example no further actions are allowed after approval, according to the user or to other factors, such as the user's role, geographic location, business logic or others. The shown user interface comprises action bar 208, which comprises action buttons for the user. The action buttons comprise leave approval details button 209 and accept/reject buttons. Action bar 208 is preferably implemented as part of the generic approval pattern, since each approval application is likely to enable viewing the request details, approving or rejecting the request. Pane 210, which appears once the user clicked or otherwise pointed at leave approval details button 209 contains data related to the request. Some data, for example employee name 212 or request status 216 appearing in area 211 are generic and will appear in any approval application. Other data items, such as vacation accrual details 220 are specific to a vacation approval application. Multiple details or actions, whether generic such as employee name 212, or specific such as the option to see related reports 232 or related documents 236, are context-related. Similarly, information area 204 comprises details specific to a leave approval application, such as leave type 224, as well as context-related details such as employee ID 228.

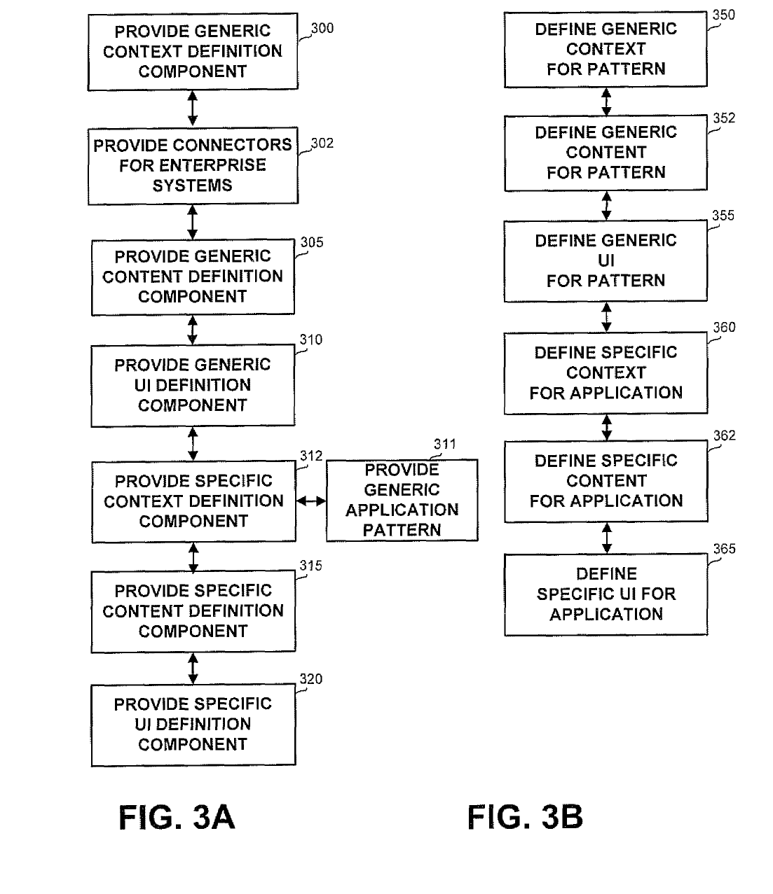

Referring now to FIGS. 3A and 3B, showing the main steps in a preferred embodiment of the disclosed method for developing applications. FIG. 3A shows the main steps in developing the required components, and FIG. 3B shows the main steps in using the components for generating a generic application pattern and an application according to the pattern. Developing the required components as shown in FIG. 3A is preferably done once and its products can be used for developing multiple application patterns. Then, multiple applications can be developed from each of the application patterns. The steps of FIG. 3A do not require any domain-specific knowledge, since the steps relate to developing the components and not to using the components in constructing application patterns or applications, but the steps of FIG. 3B do require domain specific knowledge.

When developing the required components, on step 300 the developer develops and provides tools for defining generic context relevant to the enterprise systems, such as tools for defining hierarchies, geographic locations or the like. On step 302 the developer develops and provides connectors to the enterprise systems from which the data is to be taken. The enterprise systems may include databases, specific applications, and any other system used by an enterprise for storing data and applying business logic. The developed connectors are preferably generic, i.e. enable a user to later request any data from the systems rather then supply the data in a hard coded manner. The developed connectors are preferably context-sensitive, i.e., provide connections according to the context, such as the user's role, geographic location, or the like. Enabling the user to request any type of data allows for later developing applications that use data which not a-priori known to exist within the systems. For example, a connector can be designed to let a user request a list of the available data entities and then request a specific data entity, rather than supply a mechanism for requesting specific data entities. The connectors are preferably generic also in their access method, which should not use any specific interface or access mode of the enterprise system, but can rather interface with various systems.

On step 305 the developer develops and provides a generic content-definition component. The generic content-definition component enables a user defining an application pattern to define the generic content that is required for all applications related to this pattern, and that will be consumed by the application. The generic content definition component is useful in providing the component's user, i.e. the application pattern developer, with a framework containing editing options for selecting and storing references to data items or actions used in all applications of a given pattern, and to defining pattern usage rules. The content or parts thereof may be context-sensitive, and the component is thus designed to enable the application pattern developer to relate to various context factors, such as the user's identity, role, geographic location, business logic, or others.

On step 310 the developer develops and provides a generic user-interface-definition component. The generic user-interface-definition component enables a user defining an application pattern to define the generic user-interface and its characteristics that will be used by all applications related to this pattern. The generic user-interface-definition component is designed by its developer to provide the component's user, i.e. the application pattern developer, with editing and storage options for generating a user interface common to all applications of a common pattern. The user interface preferably comprises the used components, such as controls, their appearance, and general arrangement where additional controls will appear according to context-sensitive selections made by the end user. The user interface preferably further reflects the logic and behavior to be activated in the various application states. The generic user interface optionally derives elements from, or is targeted at using an associated user-interface environment, for example Microsoft office (www.microsoft.com). Thus, elements related to Microsoft Outlook may be used as building blocks for applications, such as an e-mail object serving as a basis for a report, a request or other objects.

The generic content-definition component and the generic user-interface-definition component are further designed to allow a pattern developer using the component to apply usage rules for the pattern, for example limit the content added by an application developer to a specific application constructed using a pattern, based on the specific pattern needs, for example by adding at most one additional action and at most three additional data fields.

The generic content-definition component and the generic user-interface-definition component are designed to store their output in any useful format, such as text, XML, HTML, or any proprietary format. It will be appreciated that step 305 and step 310 can be performed separately, to produce separate components for defining the content and the user interface for an application pattern, or the steps can be performed together to generate a single component that serves the two functions.

Alternatively, a user such as a content provider can develop the pattern application, and provide on step 311 an end user with the developed pattern, including the generic content and generic user-interface.

On step 312 the developer develops and provides a specific context-definition component. The specific context-definition component is designed to receive a generic pattern, and enable a user of the component to associate specific contexts with the application pattern.

On step 315 the developer develops and provides a specific content-definition component. The specific content-definition component is designed to receive a generic pattern, and enable a user of the component to associate content specific to an application and consumed by the application with the application pattern. For example, the specific content-definition component is designed to enable a user generating a vacation request application to use a general request application pattern and add items such as a “vacation accrual” field to the application.

On step 320 the developer develops and provides a specific user-interface-definition component. The specific user-interface-definition component is designed to receive a generic pattern, and enable a user of the component to add one or more controls or other user-interface components specific to an application, to the application pattern. For example, the specific user-interface definition component is designed to enable a user generating a vacation request application to add a text field to the user interface associated with the generic application pattern.

If the pattern developer limited the addition of fields or actions to an application based on the pattern, these limitations will be enforced by the specific content-definition component.

Similar to steps 305 and 310, steps 315 and 320 also provide the associated components with contextual sensitivity for adapting the specific application to the context of the user, organization, computing resources, or the like.

Referring now to FIG. 3B, showing the main steps in using the components developed in FIG. 3A, for developing application patterns and applications.

On step 350, an application pattern developer uses the context-definition component developed on step 300 for defining the generic context relevant for the application, the context comprising for example hierarchy, geographic location and others. On step 352 an application pattern developer uses the generic content-definition component developed on step 305 and generates the context-related content relevant for the application pattern, such as the content relevant for a request pattern. On step 355 the application pattern developer uses the generic user-interface-definition component developed on step 310 and generates the context-related user-interface relevant for the application pattern. Steps 350, 352 and 355 can be performed together, if the generic content-definition component and the generic user-interface-definition component are implemented as a single component, or independently in any required order. Furthermore, steps 350, 352, 355 can be performed by the same person, or by different persons, some of whom may work on the content and others work on the user-interface. Step 352 uses the connectors developed on step 300 to retrieve data from the enterprise systems, while step 355 takes into account the environment in which the specific applications built upon the application pattern will be used. If, for example, the application is to be used via e-mail, the user-interface is designed to be incorporated into e-mail messages. The result of step 352 and step 355 is an application pattern, stored in any required format. The pattern definition, as carried out on steps 352 and 355 are preferably driven according to the needs of the end users that will interact with applications of this pattern.

On step 360 a specific-application developer develops the specific contexts for the specific application, using the specific context-definition component developed on step 312, and the application pattern or at least the generic context as developed in step 350.

On step 362 a specific-application developer develops the specific context-related content for the specific application, using the specific content-definition component developed on step 315, and the application pattern or at least the generic content as developed in step 352. On step 365 a specific-application developer develops the specific context-related user-interface for the specific application, using the specific user-interface-definition component developed on step 320, and the application pattern, or at least the generic user-interface as developed in step 355. In a preferred embodiment, the specific applications are generated as one or more plug-ins to one or more environments, such as an e-mail environment.

Thus, in order to enable the generation of a specific application, the specific application developer should receive the generic content and the generic user-interface for the pattern, and the components for defining the specific content and the specific user-interface.

It will be appreciated that the components developed and provided in association with the steps of FIG. 3A can be developed in any programming language such as C, C#, C++, Java, VB, or the like, and under any development environment, such as .Net, J2EE, or others. The components are preferably collections of computer instructions, such as executables, scripts, dynamic link libraries, static libraries or others, and can be executed by general purpose computing platforms, such as personal computer, laptop computer, network computer or the like. The method of FIG. 3B is also performed on any computing platform, by executing the components developed on the steps of FIG. 3A, in a declaration or configuration-based environments, or in a visual manner, for example by visually selecting items.

However, the usage of these components, as detailed in the steps of FIG. 3B above, is preferably done using an underlying modeling language allowing users to use configuration for most tasks. Alternatively, the components can be used and application patterns and applications developed using a visual programming environment, by coding using any programming language, by setting configuration or script files.

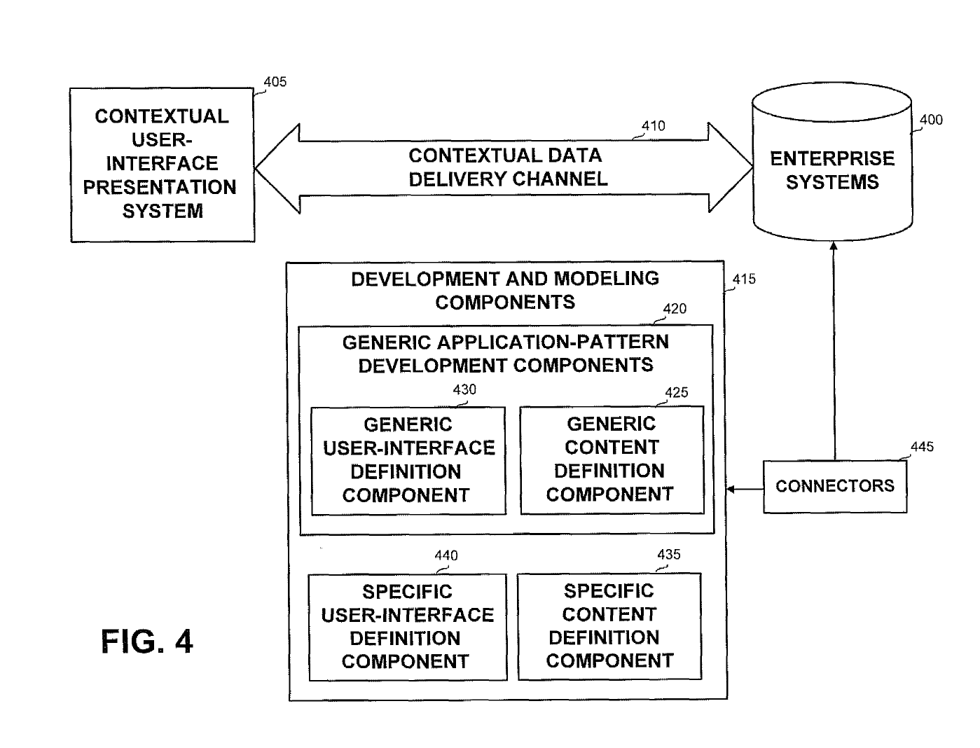

Referring now to FIG. 4, showing the main components in an apparatus for generating specific applications associated with a generic application pattern. The apparatus extracts the data to be used in the application from enterprise systems 400, which can be any generic or proprietary system, such as a database, an organizational system, or the like. The user-experience side of the applications is associated with one or more contextual user-interface presentation systems 405, such as an e-mail presentation system. Presentation systems 405 preferably include methodologies as well as user interface components, such as controls to be used. The communication between enterprise systems 400 and user-interface presentation systems 405 is preferably performed by contextual data delivery channel 410, which retrieves data, including contextual data from enterprise systems 400 and transfers it to presentation system 405. The delivery is context-related and applies business logic. For example, if a request approval application is defined so that multiple approvers have to approve the request, the data related to all approvers may be retrieved and presented to an end user. Further, user personalization settings or preferences also contribute to the dynamic and context-sensitive user interface and content of the application. For example, if a user defines that he or she wishes to view only three levels in an organizational chart, then the contextual data delivery channel will preferably accommodate dynamic context and retrieve the three levels when executing an application that involves an organizational chart.

The apparatus further comprises generic application development and modeling components 420, which comprise components for generating a generic application pattern, and components for defining a specific application. Thus, components 415 comprise generic application pattern development components 420, which further comprise generic content-definition component 425 and generic user-interface definition component 430. Once an application pattern is generated, a specific application can be developed, using the application pattern, specific content-definition component 435, and specific user-interface-definition component 440. Using specific user-interface-definition component 440, user-interface elements such as actions or controls can be added to enhance the specific application. Both generic content-definition component 425 and specific content-definition component 435 optionally retrieve context-related data, using connectors 445 developed on step 302 detailed in association with FIG. 3 above.

The disclosed method and apparatus allow for characterizing patterns, or “families” of applications, by configuring generic context and presentation, and then generating specific applications by enriching the pattern with custom content and presentation components. The generic content as well as the custom content can be general or context-related. Contextual data or content may comprise contents which take into account a user of the application, a characteristic of the user such as the user's role or geographic location, the specific computational environment used, available computing resources, business logic, or the like.

Multiple application patterns can be developed using the disclosed methods and apparatus, the application patterns include but are not limited to: workflow processes, including generation, distribution, approval and action; business activities, such as sales, mergers and others; extending contact objects, for example adding relevant fields to contacts according to the context; event delivery resolutions, including for example defining rules, delivering events, resolving events and tracking events; handling reports, including for example report generation, personalization, execution, delivery and tracking; document authoring, including writing, reviewing and distributing documents; and business collaboration.

It will be appreciated that the specific applications developed using the disclosed method and apparatus can be further customized or personalized by a user or another person, such as an administrator, by using setting files, registry, graphically editing the applications or other methods.

It will be appreciated by persons skilled in the art that the present disclosure is not limited to what has been particularly shown and described hereinabove. Rather the scope of the present disclosure is defined only by the claims which follow.

What is claimed is:

1. An apparatus for generating an application associated with an application-pattern, the apparatus comprising:
an enterprise system;
a development and modeling components comprising:
an application-pattern generation component, for generating the application-pattern, the application pattern generation component comprising:
a generic content-definition component for defining generic context-related content to be consumed by each application associated with the application-pattern; and
a generic user-interface-definition component for defining generic context-related user-interface for the application pattern;
a specific content-definition component for defining specific context-related content to be consumed by the application; and
a specific user-interface definition component for defining specific context-related user-interface characteristics associated with the application;
a connector for transferring information between the enterprise system and the development and modeling components;
a contextual user-interface presentation system for presenting the application; and
a contextual data delivery channel for retrieving data from the enterprise system and transferring the data to the contextual user-interface presentation system.

2. An apparatus for generating an application associated with an application-pattern, the apparatus comprising:
an application-pattern generation component, for generating the application-pattern, the application pattern generation component comprising:
a generic content-definition component for defining generic context-related content associated with the context, to be consumed by each application associated with the application-pattern; and
a generic user-interface-definition component for defining generic context-related user-interface associated with the context for the application pattern;
a specific content-definition component for defining specific context-related content associated with the context to be consumed by the application; and
a specific user-interface definition component for defining specific context-related user-interface characteristics associated with the context.

3. The apparatus of claim 2 wherein the application-pattern is selected from the group consisting of: a workflow pattern; a request approval pattern; a business activity pattern; extending a contact object pattern; an event resolution pattern; a report generation pattern; a document authoring pattern; and a business collaboration pattern.

4. The apparatus of claim 1 wherein the context relates to at least one item selected from the group consisting of: a user of the application; a role associated with the user of the application; a geographic location associated with the user of the application, computing resources available to the user of the application; and business logic associated with the application.

5. The apparatus of claim 2 wherein the application is a request generation application or a request approval application.

6. The apparatus of claim 2 wherein the generic context-related content or the specific context-related content relates to an at least one data item or an at least one action available to a user of the application.

7. The apparatus of claim 2 further comprising a contextual data delivery channel.

8. The apparatus of claim 7 wherein the contextual data delivery channel takes into account settings or preferences by the end-user.

9. The apparatus of claim 2 wherein the generic user-interface-definition component or the specific user-interface-definition component use Microsoft Office as a target user interface.

10. A method for enabling generation of a specific application, the specific application associated with an application pattern, the method comprising the steps of:
providing a specific context-related content-definition component for defining specific context-related content for the application; and
providing a specific context-related user-interface-definition component for defining specific context-related user-interface for the application.

11. The method of claim 10 further comprising the steps of:
providing a generic context-related content-definition component for defining generic context-related content associated with the application pattern; and
providing a generic context-related user-interface-definition component for defining generic context-related user-interface for the application pattern.

12. The method of claim 10 wherein the specific context-related content-definition component receives generic context-related content for an application pattern defined using the generic context-related content-definition component.

13. The method of claim 11 wherein the specific context-related user-interface-definition component receives generic context-related user-interface for an application pattern defined using the generic context-related content-definition component.

14. The method of claim 10 wherein the generic context-related content or the generic context-related user-interface are defined according to at least one method selected from the group consisting of: using a modeling language; using a visual programming language; using a programming language; using a configuration environment; and using a definition based environment.

15. The method of claim 11 wherein the specific context-related content or the specific context-related user-interface are defined according to at least one method selected from the group consisting of: using a modeling language; using a visual programming language; using a programming language; using a configuration environment; and using a definition based environment.

16. The method of claim 10 wherein the application pattern is selected from the group consisting of: a workflow pattern; a request approval pattern; a business activity pattern; extending a contact object pattern; an event resolution pattern; a report generation pattern; a document authoring pattern; and business collaboration pattern.

17. The method of claim 16 wherein the application is a request generation application or a request approval application.

18. The method of claim 10 wherein the generic context-related data or the specific context-related data relate to an at least one item selected from the group consisting of: a user of the application; a role associated with the user of the application; a geographic location associated with the user of the application; computing resources available to the user of the application; and business logic associated with the application.

19. The method of claim 10 wherein the generic context-related content or the specific context-related content relate to an at least one data item or an at least one action available to a user of the application.

20. The method of claim 10 further comprising the steps of:
providing generic context for the application pattern; and
providing generic user-interface for the application pattern.

21. A computer readable storage medium containing a set of instructions for a general purpose computer, the set of instructions comprising:
providing a specific context-related content-definition component for defining specific context-related content for the application; and
providing a specific context-related user-interface-definition component for defining specific context-related user-interface for the application.

22. A computer readable storage medium containing a set of instructions for a general purpose computer, the set of instructions comprising:
providing a generic context-related content-definition component for defining generic context-related content associated with the application pattern; and
providing a generic context-related user-interface-definition component for defining generic context-related user-interface for the application pattern.

23. A computer readable storage medium containing a set of instructions for a general purpose computer, the set of instructions comprising:
a specific context-related content-definition component for defining specific context-related content for an application; and
a specific context-related user-interface-definition component for defining specific context-related user-interface for the application.

24. A computer readable storage medium containing a set of instructions for a general purpose computer, the set of instructions comprising:
a generic context-related content-definition component for defining generic context-related content for an application pattern; and
a generic context-related user-interface-definition component for defining generic context-related user-interface for the application pattern.
